(19) United States
(12) Patent Application Publication
(10) Pub. No.: US 2011/0094675 A1
(43) Pub. Date: Apr. 28, 2011

(54) Electronic paper manufacturing method and double-sided adhesive tape for electronic paper formation process

(75) Inventors: Masaaki Sato, Osaka (JP); Yukio Arimitsu, Osaka (JP); Daisuke Shimokawa, Osaka (JP)

(73) Assignee: NITTO DENKO CORPORATION

(21) Appl. No.: 12/737,334

(22) PCT Filed: May 19, 2009
(86) PCT No.: PCT/JP2009/002194

§ 371 Date: Dec. 30, 2010

(30) Foreign Application Priority Data
Jul. 8, 2008 (JP) 2008-178180

(51) Int. Cl. B29C 65/50; B32B 7/12

(52) U.S. Cl. 156/297; 428/354

(57) ABSTRACT

[Object] To provide an electronic paper manufacturing method which allows formation of an electronic paper by forming thin film transistors on a support film and affixing a display layer thereto without causing wrinkling of the support film, even when the support film is thin, and which is in no need of an extra cleaning step after the formation of the electronic paper.

[Solution] The electronic paper manufacturing method includes an electronic paper formation step including the substeps of forming thin film transistors on an electronic-paper support film to give a driver layer; and affixing a display layer having an image displaying function onto the driver layer, in which the electronic paper formation step is performed while temporarily fixing the electronic-paper support film to a support plate through a double-sided pressure-sensitive adhesive tape.

### TECHNICAL FIELD

The present invention relates to a method for manufacturing an electronic paper that is expected as a next-generation visual display unit; and to a double-sided pressure-sensitive adhesive tape for electronic paper formation step, which tape is adopted to the electronic paper manufacturing method.

### BACKGROUND ART

Paper has been exclusively used as a visual display unit. However, there has arisen the need for moving from such a paper-based system (for achieving a paperless system) in consideration of increasing environmental issues in recent years.

As a possible solution to achieve such a paperless system, displays (monitors) have been used. However, such monitors have poor portability and break when let fall. In addition, they require power sources during displaying and require time for boot-up. Under these circumstances, an electronic paper receives attention as a next-generation visual display unit (Patent Literature (PTL) 1). The electronic paper can display information without the need for a power source after the inputting of the information and can boot up without delay. In addition, it is light-weighed, thin, bendable, and resistant to breakage even when let fall. Furthermore, it is capable of producing clear displays and can freely access to multiple pages. Thus, it is a display unit capable of rewriting while having satisfactory portability, veiwability, and flexibility in the true sense of the phrase “just like paper”.

The electronic paper has a structure including a display layer (front panel) having the function of displaying images and characters, and, affixed or laminated therewith, a driver layer for controlling the display layer. The driver layer generally adopts thin film transistors (hereinafter also referred to as “TFTs”) within which an electric field is generated. In this case, the driver layer is obtained, for example, by forming TFTs on a support film. In most of known electronic paper manufacturing methods, the support film is temporarily fixed to a support plate typically through a wax or adhesive; the TFT is formed on the support film to give the driver layer; and the display layer is affixed to the driver layer.

However, these manufacturing methods require a cleaning process for removing the wax or adhesive after the completion of the affixation of the display layer and the driver layer to each other. This extra cleaning process takes time and effort, impedes improvements in productivity, and, in addition, impairs the workability, because organic solvents are used for the removal of the wax or adhesive. When the formation of the TFTs or the affixation of the display layer is performed while the support film remains unfixed, the support film wrinkles. To avoid this and to prevent the support film from wrinkling, the support film should have a somewhat large thickness.

The thickness of the support film is, however, an especially important key point for the pursuit of lightness, thinness, and flexibility (bendability) of the electronic paper and is preferably minimized. Specifically, for now, there has been found no electronic paper manufacturing method which can form TFTs on a support film to give a driver layer and can affix the driver layer to a display layer to form an electronic paper without causing wrinkling of the support film even when the support film used is thin, and which eliminates the need for providing an extra cleaning process after the formation of the electronic paper.

### Citation List

### Patent Literature

PTL 1: Japanese Unexamined Patent Application Publication (JP-A) No. 2004-46792

### SUMMARY OF INVENTION

### Technical Problem

Accordingly, an object of the present invention is to provide an electronic paper manufacturing method, which method can form TFTs on a support film to give a driver layer and can affix the driver layer to a display layer to form an electronic paper without causing wrinkling of the support film even when the support film used is thin, and which method eliminates the need for providing an extra cleaning process after the formation of the electronic paper.

### Solution to Problem

After intensive investigations to solve the problem, the present inventors have found that, by performing the formation of TFTs on a support film (electronic-paper support film) to give a driver layer and the affixation of a display layer having an image displaying function onto the driver layer while temporarily fixing the support film through a double-sided pressure-sensitive adhesive tape, the TFTs can be easily formed to give the driver layer without causing wrinkling of the support film, and the driver layer can be affixed to the display layer without causing wrinkling even when the electronic-paper support film is thin. They have also found that the double-sided pressure-sensitive adhesive tape can be removed without causing adhesive deposit (adhesive transfer) after the formation of the electronic paper, and this eliminates the need for cleaning the backside of the electronic paper after the removal of the adhesive tape. The present invention has been made based on these findings.

Specifically, the present invention provides, in an embodiment, a method for manufacturing an electronic paper, which method includes an electronic paper formation step, the step including substeps of forming one or more thin film transistors on or above an electronic-paper support film to give a driver layer; and affixing a display layer having an image displaying function onto the driver layer, in which the electronic paper formation step is performed while temporarily fixing the electronic-paper support film to a support plate through a double-sided pressure-sensitive adhesive tape.

The method preferably further include the step of peeling the electronic paper from the support plate after the electronic paper formation step.

The double-sided pressure-sensitive adhesive tape is preferably one including a heat-peelable pressure-sensitive adhesive layer as at least one side thereof. More preferably, the double-sided pressure-sensitive adhesive tape is a heat-peelable double-sided pressure-sensitive adhesive tape comprising a substrate layer and two heat-peelable pressure-sensitive adhesive layers each containing heat-expandable microspheres, one of the adhesive layers being present on one side of the substrate layer, and the other of the adhesive layers being present on the other side of the substrate layer.

The present invention provides, in another embodiment, a double-sided pressure-sensitive adhesive tape for electronic paper formation step, which tape is adopted to the electronic paper manufacturing method.

### Advantageous Effects of Invention

The electronic paper manufacturing method according to the present invention allows easy formation of TFTs without causing wrinkling of the electronic-paper support film even when the electronic-paper support film used is thin, because the electronic-paper support film is temporarily fixed through the double-sided pressure-sensitive adhesive tape. In addition, the method allows easy and simple affixation of the display layer to the driver layer without causing wrinkling of the electronic-paper support film in the affixation step. The method also allows, after the electronic paper formation step, easy and clean removal of the electronic paper from the double-sided pressure-sensitive adhesive tape, which has been used for temporary fixing, without adhesive deposit and thereby allows automatization of the formation step and peeling step. In addition, the method eliminates the need for cleaning the side of the electronic paper which has been bonded with the double-sided pressure-sensitive adhesive tape (electronic paper backside) after the peeling step and can thereby have significantly improved productivity. Furthermore, the method excels in workability and does not cause problems such as environmental pollution, because the method does not need to use, for example, organic solvents which have been used in the cleaning processes in customary manufacturing methods.

### BRIEF DESCRIPTION OF DRAWINGS

FIG. 1 is a schematic cross-sectional view of a double-sided pressure-sensitive adhesive tape for use in the electronic paper manufacturing method, according to an embodiment of the present invention.

FIG. 2 is a schematic cross-sectional view of another double-sided pressure-sensitive adhesive tape for use in the electronic paper manufacturing method, according to another embodiment of the present invention.

FIG. 3 depicts schematic diagrams (cross-sectional views) illustrating an electronic paper manufacturing method as an embodiment of the present invention.

### DESCRIPTION OF EMBODIMENTS

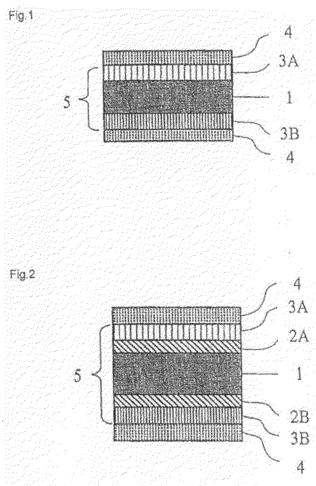

Embodiments of the present invention will be illustrated in detail below with reference to the attached drawings according to necessity. FIG. 1 is a schematic cross-sectional view illustrating a double-sided pressure-sensitive adhesive tape according to an embodiment of the present invention, for use in the electronic paper manufacturing method. The double-sided pressure-sensitive adhesive tape includes a substrate layer 1; two pressure-sensitive adhesive layers 3A and 3B, one of which being present on one side of the substrate layer 1, and the other being present on the other side of the substrate layer 1; and two separators 4 present on the pressure-sensitive adhesive layers 3A and 3B, respectively.

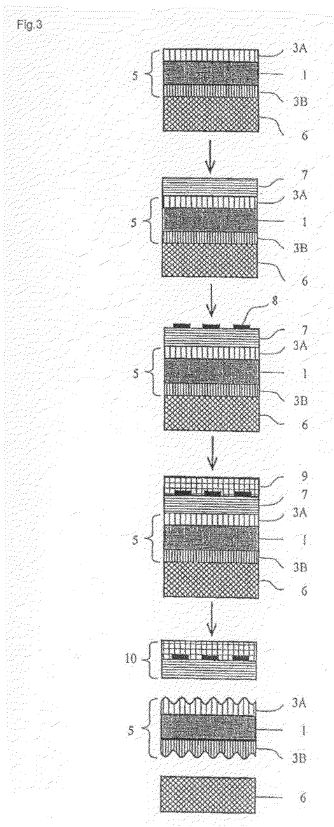

FIG. 2 is a schematic cross-sectional view illustrating another double-sided pressure-sensitive adhesive tape according to another embodiment of the present invention, for use in the electronic paper manufacturing method. This double-sided pressure-sensitive adhesive tape includes a substrate layer 1; two rubber-like organic elastic layers 2A and 2B, one of which being present on one side of the substrate layer 1, and the other being present on the other side of the substrate layer 1; two pressure-sensitive adhesive layers 3A and 3B being present on the rubber-like organic elastic layers 2A and 2B, respectively; and two separators 4 present on the pressure-sensitive adhesive layers 3A and 3B, respectively.

FIG. 3 depicts schematic diagrams (cross-sectional views) illustrating an electronic paper manufacturing method according to an embodiment of the present invention. The electronic paper manufacturing method illustrated in FIG. 3 includes the following steps of:

1. affixing a support plate 6 to one side of a double-sided pressure-sensitive adhesive tape 5;

2. affixing an electronic-paper support film 7 to the other side of the double-sided pressure-sensitive adhesive tape 5 opposite to the support plate 6;

3. forming TFTs 8 on the affixed electronic-paper support film 7;

4. affixing a display layer (front panel) 9 to the electronic-paper support film 7 on which TFTs 8 have been formed; and

5. carrying out a heating treatment to allow the pressure-sensitive adhesive layers 3A and 3B of the double-sided pressure-sensitive adhesive tape 5 to expand and/or blister to thereby peel the resulting electronic paper 10 from the support plate 6.

The electronic paper manufacturing method according to the present invention has an electronic paper formation step including the substeps of forming one or more thin film transistors on an electronic-paper support film to give a driver layer; and affixing a display layer having an image displaying function onto the driver layer, in which the electronic paper formation step is performed while temporarily fixing the electronic-paper support film to a support plate through a double-sided pressure-sensitive adhesive tape.

[Double-Sided Pressure-Sensitive Adhesive Tape]

The double-sided pressure-sensitive adhesive tape according to the present invention is not limited, as long as capable of being peeled off or removed from the electronic paper and the support plate. The double-sided pressure-sensitive adhesive tape according to the present invention is preferably a double-sided pressure-sensitive adhesive tape having a substrate layer (backing layer or carrier layer) from the viewpoints typically of satisfactory handleability and workability. In addition, the double-sided pressure-sensitive adhesive tape according to the present invention preferably further includes rubber-like organic elastic layers, in addition to the pressure-sensitive adhesive layers and the substrate layer. The adhesive faces of the double-sided pressure-sensitive adhesive tape according to the present invention may be laminated with and protected by separators (release liners) before use.

[Pressure-Sensitive Adhesive Layers]

The double-sided pressure-sensitive adhesive tape according to the present invention is a pressure-sensitive adhesive tape having pressure-sensitive adhesive layers on or above both sides thereof. Examples of the pressure-sensitive adhesive layers include (regular) pressure-sensitive adhesive. layers containing no heat-expandable microspheres; active-energy-ray-curable pressure-sensitive adhesive layers; and heat-peelable pressure-sensitive adhesive layers.

The double-sided pressure-sensitive adhesive tape according to the present invention may have, as the pressure-sensitive adhesive layers, two pressure-sensitive adhesive layers of different types, one of which is present on one side (e.g., the side to be affixed to the electronic-paper support film) and the other is present on the other side (e.g., the side to be affixed to the support plate) or may have two pressure-sensitive adhesive layers of the same type. Exemplary combinations of a pressure-sensitive adhesive layer to be present on one side (for example, the side to be affixed to the electronic-paper support film) and another pressure-sensitive adhesive layer to be present on the other side (for example, the side to be affixed to the support plate) include (heat-peelable pressure-sensitive adhesive layer)/(active-energy-ray-curable pressure-sensitive adhesive layer), (heat-peelable pressure-sensitive adhesive layer)/(pressure-sensitive adhesive layer), (heat-peelable pressure-sensitive adhesive layer)/(heat-peelable pressure-sensitive adhesive layer), (active-energy-ray-curable pressure-sensitive adhesive layer)/(pressure-sensitive adhesive layer), (active-energy-ray-curable pressure-sensitive adhesive layer)/(active-energy-ray-curable pressure-sensitive adhesive layer), and (pressure-sensitive adhesive layer)/(pressure-sensitive adhesive layer).

The double-sided pressure-sensitive adhesive tape according to the present invention is preferably a heat-peelable double-sided pressure-sensitive adhesive tape, in which the pressure-sensitive adhesive layer present on at least one side thereof (of which the side to be affixed to the electronic-paper support film is preferred) is a heat-peelable pressure-sensitive adhesive layer. The double-sided pressure-sensitive adhesive tape is more preferably a heat-peelable double-sided pressure-sensitive adhesive tape having two heat-peelable pressure-sensitive adhesive layers present on both sides thereof [having the combination of (heat-peelable pressure-sensitive adhesive layer)/(heat-peelable, pressure-sensitive adhesive layer)], because this adhesive tape allows easy control of the adhesive strengths, can exhibit high adhesive strengths when certain adhesive strengths are needed, and can show remarkably lowered adhesive strengths by a simple procedure when adhesive strengths become unnecessary.

Such a heat-peelable pressure-sensitive adhesive layer is characterized by containing a pressure-sensitive adhesive for imparting tackiness (adhesiveness) and heat-expandable microspheres (microcapsules) for imparting thermal expandability; allowing the contained heat-expandable, microspheres to expand and/or blister by heating; whereby significantly reducing the contact area between the adherend and the pressure-sensitive adhesive layer; and abruptly reducing its adhesive strength. The heat-peelable pressure-sensitive adhesive layer has high adhesiveness before heating but can be easily peeled off by heating when peeling is needed. The microcapsulated blowing agent (microspheres) can stably exhibit satisfactory peelability.

The pressure-sensitive adhesive(s) used herein is preferably one that allows minimum restriction of the expansion and/or blistering of the heat-expandable microspheres upon heating, and examples thereof include known pressure-sensitive adhesives such as rubber pressure-sensitive adhesives, acrylic pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, styrene-diene block copolymer pressure-sensitive adhesives, and pressure-sensitive adhesives having improved creep properties and corresponding to these pressure-sensitive adhesives, except for further containing one or more hot-melt resins having a melting point of about 200° C. or lower (see, for example, Japanese Unexamined Patent Application Publication (JP-A) No. S56(1981)-61468, Japanese Unexamined Patent Application Publication (JP-A) No. S63(1988)-30205, and Japanese Unexamined Patent Application Publication (JP-A) No. S63(1988)-17981). Each of such pressure-sensitive adhesives can be used alone or in combination. The pressure-sensitive adhesive may further contain, in addition to the adhesive component (base polymer), appropriate additives including crosslinking agents such as polyisocyanates and alkyl-etherified melamine compounds; tackifiers such as rosin derivative resins, polyterpene resins, petroleum resins, and oil-soluble phenol resins; plasticizers; fillers; and age inhibitors.

The pressure-sensitive adhesive(s) for use herein is generally selected from rubber pressure-sensitive adhesives each containing a rubber such as natural rubber or a synthetic rubber of every kind as a base polymer; and acrylic pressure-sensitive adhesives containing, as a base polymer, an acrylic polymer (a homopolymer or copolymer) derived from one or more alkyl esters of (meth)acrylic acids as monomer components. Exemplary alkyl esters of (meth)acrylic acids (alkyl(meth)acrylates) include alkyl esters whose alkyl moiety having 1 to 20 carbon atoms, such as methyl ester, ethyl ester, propyl ester, isopropyl ester, butyl ester, isobutyl ester, s-butyl ester, t-butyl ester, pentyl ester, hexyl ester, heptyl ester, octyl ester, 2-ethylhexyl ester, isooctyl ester, isodecyl ester, dodecyl ester, tridecyl ester, pentadecyl ester, hexadecyl ester, heptadecyl ester, octadecyl ester, nonadecyl ester, and eicosyl ester.

The acrylic polymer may further contain one or more units corresponding to other monomer components copolymerizable with the alkyl(meth)acrylates, where necessary typically for improving cohesive strength, thermal stability, and/or crosslinking properties. Examples of such copolymerizable monomer components include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as hydroxyethyl(meth)acrylates, hydroxypropyl(meth)acrylates, hydroxybutyl(meth)acrylates, hydroxyhexyl(meth)acrylates, hydroxyoctyl(meth)acrylates, hydroxydecyl(meth)acrylates, hydroxylauryl(meth)acrylates, and (4-hydroxymethylcyclohexyl)methyl methacrylate; sulfo-containing monomers such as styrenesulfonic acid, allylsulfonic acid, 2-(meth)acrylamido-2-methylpropanesulfonic acids, (meth)acrylamidopropanesulfonic acids, sulfopropyl(meth)acrylates, and (meth)acryloyloxynaphthalenesulfonic acids; (N-substituted) amide monomers such as (meth)acrylamides, N,N-dimethyl(meth)acrylamides, butyl(meth)acrylamides, N-methylol(meth)acrylamides, and N-methylolpropane(meth)acrylamides; aminoalkyl(meth)acrylate monomers such as aminoethyl(meth)acrylates, N,N-dimethylaminoethyl(meth)acrylates, and t-butylaminoethyl(meth)acrylates; alkoxyalkyl(meth)acrylate monomers such as methoxyethyl(meth)acrylates and ethoxyethyl(meth)acrylates; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimides, N-(meth)acryloyl-6-oxyhexamethylenesuccinimides, and N-(meth)acryloyl-8-oxyoctamethylenesuccinimides; vinyl monomers such as vinyl acetate, vinyl propionate, N-vinylpyrrolidone, methylvinylpyrrolidones, vinylpyridines, vinylpiperidones, vinylpyrimidines, vinylpiperazines, vinylpyrazines, vinylpyrroles, vinylimidazoles, vinyloxazoles, vinylmorpholines, N-vinylcarboxamides, styrene, α-methylstyrene, and N-vinylcaprolactam; cyano acrylate monomers such as acrylonitrile and methacrylonitrile; epoxy-containing acrylic monomers such as glycidyl(meth)acrylates; glycol acrylic ester monomers such as polyethylene glycol(meth)acrylates, polypropylene glycol(meth)acrylates, methoxyethylene glycol(meth)acrylates, and methoxypolypropylene glycol(meth)acrylates; acrylate monomers having, for example, a heterocycle, halogen atom, or silicon atom, such as tetrahydrofurfuryl(meth)acrylates, fluorine-containing (meth)acrylates, and silicone(meth)acrylates; multifunctional monomers such as hexanediol di(meth)acrylates, (poly)ethylene glycol di(meth)acrylates, (poly)propylene glycol di(meth)acrylates, neopentyl glycol di(meth)acrylates, pentaerythritol di(meth)acrylates, trimethylolpropane tri(meth)acrylates, pentaerythritol tri(meth)acrylates, dipentaerythritol hexa(meth)acrylates, epoxy acrylates, polyester acrylates, and urethane acrylates; olefinic monomers such as isoprene, butadiene, and isobutylene; and vinyl ether monomers such as vinyl ether (divinyl ether). Each of such monomer components can be used alone or in combination.

The amount of crosslinking agents, when added to the pressure-sensitive adhesive component (base polymer), is preferably 0.01 to 10 parts by weight, and more preferably 0.01 to 8 parts by weight, per 100 parts by weight of the base polymer. Exemplary crosslinking agents usable herein include isocyanate crosslinking agents, epoxy crosslinking agents, melamine crosslinking agents, thiuram crosslinking agents, resinous crosslinking agents, and metal chelate crosslinking agents.

The pressure-sensitive adhesive for use herein is more preferably a pressure-sensitive adhesive containing a base polymer having a dynamic elastic modulus in the range of 5000 to 1000000 Pa at temperatures from room temperature to 150° C. Such pressure-sensitive adhesive shows an appropriate bond strength before a heating treatment and has a satisfactorily lowered bond strength after the heat treatment, and these properties are in good balance.

The heat-expandable microspheres are not limited, as long as being microspheres each composed of an elastic shell and a material encapsulated in the shell, which material easily gasifies and expands by heating, and examples thereof include isobutane, propane, and pentane. The shell is often formed by a hot-melt material (heat-fusible material) or a material that breaks as a result of thermal expansion. Exemplary materials for constituting the shell include vinylidene chloride-acrylonitrile copolymers, poly(vinyl alcohol)s, poly(vinyl butyral)s, poly(methyl methacrylate)s, polyacrylonitriles, poly(vinylidene chloride)s, and polysulfones. The heat-expandable microspheres can be produced according to a common process such as coacervation process or interfacial polymerization. The heat-expandable microspheres for use in the present invention can adopt commercial products such as one supplied by Matsumoto Yushi-Seiyaku Co., Ltd. under the trade names of “Matsumoto Microsphere F30D” and “Matsumoto Microsphere F50D”.

The heat-expandable microspheres are preferably heat-expandable microspheres having such a suitable strength that they do not rupture until they expand to a coefficient of cubic expansion of 5 times or more, more preferably 7 times or more, and especialy preferably 10 times or more, in order to efficiently reduce the bond strength of the pressure-sensitive adhesive layer by a heating treatment.

Though appropriately settable according typically to the coefficient of expansion of the heat-peelable pressure-sensitive adhesive layer and to how much the adhesive strength (bond strength) will be lowered, the amount of the heat-expandable microspheres is typically 1 to 150 parts by weight, and preferably 5 to 100 parts by weight, per 100 parts by weight of the base polymer (e.g., an acrylic polymer when the pressure-sensitive adhesive is an acrylic pressure-sensitive adhesive) of the heat-peelable pressure-sensitive adhesive layer. The heat-expandable microspheres, if used in an amount of less than 1 part by weight, may not help the heat-peelable pressure-sensitive adhesive layer(s) to become sufficiently easily peelable. In contrast, the heat-expandable microspheres, if used in an amount of more than 150 parts by weight, may cause the heat-peelable pressure-sensitive adhesive layer(s) to have a rough or bumpy surface and thereby show insufficient adhesiveness. In the present invention, the heat-peelable pressure-sensitive adhesive layers have only to be easily peeled off to such an extent that the electronic paper does not break; and the heat-expandable microspheres are used in a somewhat smaller amount so as to form a surface in a stable state when the heat-peelable pressure-sensitive adhesive layers are to be formed thin. From these viewpoints, the heat-expandable microspheres are used optimally in an amount about one half the amount necessary for being peeled off completely (the adhesive strength becomes zero). Specifically, the optimum amount of the heat-expandable microspheres is 30 to 80 parts by weight.

The heat-peelable pressure-sensitive adhesive layer(s) for use in the present invention has a thermal expansion initiating temperature of generally 70° C. to 160° C., and preferably 75° C. to 110° C., although the temperature may be set as appropriate according typically to the thermal stability of the electronic paper and is not especially limited. The heat-peelable pressure-sensitive adhesive layer(s), if having a thermal expansion initiating temperature of lower than 70° C., may undergo thermal expansion and thereby have a lowered bond strength to show inferior bonding reliability in a high-temperature environment, when the heat-peelable pressure-sensitive adhesive layer is exposed to such high-temperature environment typically during the formation of TFTs on the electronic-paper support film temporarily fixed with the double-sided pressure-sensitive adhesive tape. In contrast, the heat-peelable pressure-sensitive adhesive layer(s), if having a thermal expansion initiating temperature of higher than 160° C., may require a higher temperature in the peeling step to exhibit satisfactory peelability, and this may cause, for example, thermal deformation and subsequent failure of the electronic paper. As used herein the term “thermal expansion initiating temperature” refers to a temperature at which the heat-expandable microspheres start expanding, in which the thermal expansion initiating temperature of the heat-expandable microspheres is measured with a thermal analyzer (supplied by SII NanoTechnology Inc. under the trade name of “TMA/SS6100”) according to an expansion method (load: 19.6 N, probe: 3 mm in diameter).

The thermal expansion initiating temperature can be controlled as appropriate typically through the type and particle diameter distribution of the heat-expandable microspheres. In particular, the thermal expansion initiating temperature can be easily controlled by classifying material heat-expandable microspheres to give heat-expandable microspheres having a sharp particle diameter distribution. The classification can be performed according to a known process including any of dry processes and wet processes. Exemplary classification apparatuses for use herein include known classification apparatuses such as gravitational classifiers, inertial classifiers, and centrifugal classifiers.

The heat-peelable pressure-sensitive adhesive layer or layers are preferably positioned as surface layers (outermost layers) of the double-sided pressure-sensitive adhesive tape, but they may be positioned as inner layers other than surface layers. In this case, such layers having the function of imparting heat peelability to outermost layers of the sheet (tape) are considered as “heat-peelable pressure-sensitive adhesive layers” in the present invention.

The two heat-peelable pressure-sensitive adhesive layers, one of which is present on one side (for example, the side to be affixed to the electronic-paper support film) and the other is present on the other side (for example, the side to be affixed to the support plate), of the double-sided pressure-sensitive adhesive tape may contain heat-expandable microspheres which will expand and/or blister at the same temperature or may respectively contain heat-expandable microspheres of different types which will expand and/or blister at different temperatures. The two heat-peelable pressure-sensitive adhesive layers in the present invention preferably contain heat-expandable microspheres that will expand and/or blister at the same temperature, because this allows the double-sided pressure-sensitive adhesive tape to be peeled off from the electronic paper and from the support plate simultaneously through one pass of heating treatment in the peeling step for peeing the electronic paper from the support plate, thus reducing energy cost.

The pressure-sensitive adhesive layers may be formed according to an appropriate process such as dry coating process, dry lamination process, or coextrusion process. In the dry coating process, a coating composition containing the pressure-sensitive adhesive and heat-expandable microspheres is prepared where necessary using a solvent, and the composition is applied to the substrate layer or rubber-like organic elastic layer. In the dry lamination process, the above-prepared coating composition is applied to a suitable separator (such as a release paper) to form a pressure-sensitive adhesive layer thereon, and the pressure-sensitive adhesive layer is transferred (moved) to the substrate layer or rubber-like organic elastic layer. In the coextrusion process, a resin composition containing materials for the formation of the substrate layer is coextruded with a resin composition containing materials for the formation of the pressure-sensitive adhesive layer. The pressure-sensitive adhesive layers may each have a single-layer structure or multilayer-structure.

The pressure-sensitive adhesive layers may each have a thickness of typically about 5 to 300 μm, and preferably about 10 to 100 μm. In the case of a heat-peelable pressure-sensitive adhesive layer containing heat-expandable microspheres, the thickness thereof is not limited, as long as being larger than the largest particle diameter of the heat-expandable microspheres. The pressure-sensitive adhesive layers, if having excessively large thicknesses, may undergo cohesive failure upon peeling after the heating treatment and may thereby cause adhesive deposit on the electronic paper, thus showing inferior peelability. In contrast, the pressure-sensitive adhesive layers, if having excessively small thicknesses, may show insufficient adhesive strengths and may fail to hold the adherends satisfactorily during temporary fixing. Particularly when the pressure-sensitive adhesive layers are heat-peelable pressure-sensitive adhesive layers containing heat-expandable microspheres, such excessively thin heat-peelable pressure-sensitive adhesive layers may have inferior surface smoothness due to surface roughness caused by the heat-expandable microspheres, may thereby have insufficient adhesiveness and may involuntarily drop off during temporary fixing. In addition, the excessively thin heat-peelable pressure-sensitive adhesive layers may not sufficiently deform through the heating treatment and may not show sufficiently smoothly lowered bond strengths. In addition, they may require the use of heat-expandable microspheres having excessively small particle diameters in order to maintain certain adhesiveness during temporary fixing.

The double-sided pressure-sensitive adhesive tape has an adhesive strength between the support plate and one of the two pressure-sensitive adhesive layers and an adhesive strength between the support film and the other pressure-sensitive adhesive layer each preferably about 0.5 to 7.0 N/20 mm, and more preferably 0.5 to 5.0 N/20 mm. The double-sided pressure-sensitive adhesive tape, if having excessively low adhesive strengths, may fail to hold the support film, and this can cause the separation between the support plate and the pressure-sensitive adhesive layer and/or the separation between the support film and the pressure-sensitive adhesive layer during the formation of TFTs on the support film. The double-sided pressure-sensitive adhesive tape, if having excessively high adhesive strengths, may fail to have sufficiently lowered adhesive strengths upon peeling of the pressure-sensitive adhesive layers from the support film and from the support plate, respectively, even after they blister as a result of heating. Such remaining adhesiveness between the support plate and one pressure-sensitive adhesive layer and remaining adhesiveness between the support film and the other pressure-sensitive adhesive layer may cause failure of the formed TFTs. The adhesive strengths herein are measured in accordance with Japanese Industrial Standards (JIS) Z 0237.

The pressure-sensitive adhesive layers of the double-sided pressure-sensitive adhesive tape have gel fractions (proportions of solvent-insoluble substances) of preferably 50% (percent by weight) or more, and more preferably 70% (percent by weight) or more. The pressure-sensitive adhesive layers, if having gel fractions of less than 50%, may fail to suppress the shrinkage of the support film due to heat applied or generated during the formation step, and the support film may fail to remain flat (fail to maintain a smooth state) during the formation of TFTs on the support film. As used herein the term “gel fraction” refers to a proportion of substances not dissolved in toluene, as measured by sampling a predetermined amount of the pressure-sensitive adhesive and immersing the sample in a toluene solution at 25° C. for 7 days. The test method will be described later in evaluation tests.

[Substrate Layer]

A substrate for constituting the substrate layer (backing layer) is not especially limited and can be any of various substrates, including fibrous substrates such as woven fabrics, nonwoven fabrics, felts, and nets; paper substrates such as paper of every kind; metallic substrates such as metallic foil and metal plates; plastic substrates such as films and sheets of various resins; rubber substrates such as rubber sheets; foams such as foam sheets; and laminates of them. Exemplary materials for the plastic substrates include polyesters such as poly(ethylene terephthalate)s, poly(ethylene naphthalate)s, poly(butylene terephthalate)s, and poly(butylene naphthalate)s; polyolefins such as polyethylenes, polypropylenes, and ethylene-propylene copolymers; poly(vinyl alcohol)s; poly(vinylidene chloride)s; poly(vinyl chloride)s; vinyl chloride-vinyl acetate copolymers; poly(vinyl acetate)s; polyamides; polyimides; celluloses; fluorocarbon resins; polyethers; polystyrenic resins such as polystyrenes; polycarbonates; and poly(ether sulfone)s. The substrate layer may have a single-layer structure or multilayer structure.

The substrate layer has a thickness of preferably about 500 μm or less, and more preferably about 5 to 250 μm, though the thickness is not critical.

Where necessary, the surfaces of the substrate layer may have been subjected to a customary surface treatment such as chromate treatment, exposure to ozone, exposure to flame, exposure to a high-voltage electric shock, a treatment with ionizing radiation, or another chemical or physical oxidizing treatment. The surface treatment is performed to improve the adhesion typically with the pressure-sensitive adhesive layers.

[Rubber-Like Organic Elastic Layers]

The double-sided pressure-sensitive adhesive tape according to the present invention preferably further include two rubber-like organic elastic layers respectively present between the substrate layer and one of the two pressure-sensitive adhesive layers and between the substrate layer and the other pressure-sensitive adhesive layer. The rubber-like organic elastic layers have the function of allowing a surface of the double-sided pressure-sensitive adhesive tape to satisfactorily conform the surface shape of the electronic-paper support film to thereby increase the contact area therebetween upon bonding of the double-sided pressure-sensitive adhesive tape to the electronic-paper support film. When the pressure-sensitive adhesive layers of the double-sided pressure-sensitive adhesive tape are heat-peelable pressure-sensitive adhesive layers, the rubber-like organic elastic layers also have the function of helping the heat-peelable pressure-sensitive adhesive layers to three-dimensionally structurally change to form an undulating structure upon the peeling of the double-sided pressure-sensitive adhesive tape from the electronic paper and from the support plate.

For satisfactorily exhibiting the above functions, the rubber-like organic elastic layers are preferably made from any of natural rubbers, synthetic rubbers, and rubber-like elastic synthetic resins, each having a Type D Shore D hardness of 50 or less and more preferably 40 or less, as determined according to the American Society for Testing and Materials (ASTM) D-2240 standard.

Examples of the synthetic rubbers and rubber-like elastic synthetic resins include synthetic rubbers such as nitrile rubbers, diene rubbers, and acrylic rubbers; thermoplastic elastomers such as polyolefinic elastomers and polyester elastomers; and rubber-like elastic synthetic resins such as ethylene-vinyl acetate copolymers, polyurethanes, polybutadienes, and soft poly(vinyl chloride)s. In this connection, even inherently hard or rigid polymers, such as poly(vinyl chloride)s, can develop rubber-like elasticity by suitably combining with compounding agents, such as plasticizers and flexibilizers, to give a composition; and the resulting composition is also usable as a material for constituting the rubber-like organic elastic layers. In addition, the above-exemplified pressure-sensitive adhesives for constituting the pressure-sensitive adhesive layers are also preferably used as materials for constituting the rubber-like organic elastic layers.

The rubber-like organic elastic layers each have a thickness of generally about 5 to 300 μm, and preferably about 5 to 100 μm. The rubber-like organic elastic layers, if having an excessively large thickness, may impede the three-dimensional structural deformation of the pressure-sensitive adhesive layer in the peeling step and may thereby often cause insufficient peelability.

The rubber-like organic elastic layers can be formed according to a suitable process such as coating process, dry lamination process, or coextrusion process. In the coating process, a coating composition containing materials for the formation of the rubber-like organic elastic layers, such as the natural rubber, synthetic rubber or rubber-like elastic synthetic resin, is applied to the substrate layer. In the dry lamination process, the substrate layer is bonded with a film composed of the material for the formation of the rubber-like organic elastic layers or with a multilayer film which includes one or more pressure-sensitive adhesive layers and, formed thereon, a layer composed of the material for the formation of the rubber-like organic elastic layers. In the coextrusion process, a resin composition containing materials for the formation of the substrate layer is coextruded with a resin composition containing the material for the formation of the rubber-like organic elastic layers.

The material for the formation of the rubber-like organic elastic layers may further contain, according to necessity, other components including known additives such as fillers, flame retardants, age inhibitors, antistatic agents, softeners, ultraviolet absorbers, antioxidants, plasticizers, and surfactants.

The material for the formation of the rubber-like organic elastic layers may further contain a crosslinking agent, and the amount of the crosslinking agent is preferably 0.01 to 10 parts by weight, and more preferably 0.01 to 8 parts by weight, based on 100 parts by weight of the material for the formation of the rubber-like organic elastic layers. The crosslinking agent can be any known or common crosslinking agents such as isocyanate crosslinking agents, epoxy crosslinking agents, melamine crosslinking agents, thiuram crosslinking agents, resinous crosslinking agents, and metal chelate crosslinking agents.

[Separators]

The double-sided pressure-sensitive adhesive tape according to the present invention may further include one or more separators (release liners) provided on the surfaces of the respective pressure-sensitive adhesive layers, typically for protecting the surfaces of the pressure-sensitive adhesive layers and for inhibiting blocking thereof. The separators will be removed when the double-sided pressure-sensitive adhesive tape is affixed to adherends, and they may not necessarily be provided. The separators are not especially limited and can be any of, for example, known or common release papers. Exemplary separators usable herein include bases having a release layer made typically from a plastic film or paper whose surface has been treated with a release agent such as a silicone-, long-chain alkyl-, fluorine-, or molybdenum sulfide-release agent; low-adhesive bases made from fluorocarbon polymers such as polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers; and low-adhesive bases made from nonpolar polymers including olefinic resins (such as polyethylenes and polypropylenes).

The double-sided pressure-sensitive adhesive tape according to the present invention may be provided with two separators on the both adhesive faces thereof. Alternatively, the double-sided pressure-sensitive adhesive tape may be provided with one separator on one of the two adhesive faces thereof, which separator has a backside release layer, and the tape (sheet) is wound so that the backside release layer of the separator comes in contact with the other adhesive face of the tape.

The double-sided pressure-sensitive adhesive tape according to the present invention, when used as a double-sided pressure-sensitive adhesive tape for electronic paper formation step, can be firmly affixed to the electronic-paper support film for temporary fixing during the electronic paper formation step and can be easily peeled off without causing adhesive deposit after the completion of the electronic paper formation step.

Particularly when the double-sided pressure-sensitive adhesive tape is a heat-peelable double-sided pressure-sensitive adhesive tape containing heat-expandable microspheres, the tape before subjected to a heating treatment has a satisfactory bond strength, allows secure temporary fixing of the electronic-paper support film, and thereby allows smooth formation of the electronic paper. Once becoming unnecessary, the double-sided pressure-sensitive adhesive tape is subjected to a heating treatment and can thereby be removed from the electronic paper without contamination due typically to adhesive deposit. This is because the heating treatment allows the heat-expandable microspheres in the tape to expand and/or blister and thereby allows the pressure-sensitive adhesive layer(s) to three-dimensionally structurally change to form a undulating structure; this causes the pressure-sensitive adhesive layer to have an abruptly reduced contact area with the electronic paper and to have a remarkably lowered bond strength with respect to the electronic paper.

“Electronic Paper Manufacturing Method”

The electronic paper manufacturing method according to the present invention includes an electronic paper formation step including the substeps of forming one or more TFTs on an electronic-paper support film to give a driver layer; and affixing a display layer having an image displaying function onto the driver layer, in which the electronic paper formation step is performed while temporarily fixing the electronic-paper support film to a support plate through a double-sided pressure-sensitive adhesive tape.

[Electronic Paper Formation Step]

The driver layer is obtained by initially temporarily fixing the electronic-paper support film to the support plate through the double-sided pressure-sensitive adhesive tape, and forming one or more TFTs on the temporarily-fixed electronic-paper support film. A material for constituting the support plate is not especially limited, as long as capable of holding the affixed electronic-paper support film, but is preferably one being harder or more rigid than the electronic-paper support film. Exemplary materials herein include silicon, glass, stainless steel (SUS) plates, copper plates, and acrylic plates. The support plate has a thickness typically preferably 0.4 mm or more (for example, 0.4 to 5.0 mm).

The way to affix the electronic-paper support film to the support plate through the double-sided pressure-sensitive adhesive tape is not limited, as long as capable of bringing the support plate and the electronic-paper support film into intimate contact with each other. The affixation can be performed typically using a roller, a lancet, or a pressing machine.

A material for constituting the electronic-paper support film is not especialy limited, as long as being a material that can exhibit flexibility even after affixation with the display layer. Exemplary materials usable herein include films made from polyesters such as poly(ethylene terephthalate)s (PETs) and poly(ethylene naphthalate) (PENs). The electronic-paper support film may be a transparent film or opaque film. It may also be a color-printed film, a colorant-containing film, or, where necessary, a metallized film deposited typically with gold, silver, or aluminum.

The electronic-paper support film has a thickness of typically about 400 μm or less, preferably about 25 to 350 μm, and particularly preferably about 38 to 300 μm.

TFTs to be formed on the electronic-paper support film may be of any type not restricted and can be of, for example, staggered type, inverted staggered type, coplanar type, or inverted coplanar type. Each of components constituting the transistors, such as semiconductor layer, gate insulating film, electrodes, and protective insulating film, can be formed each as a thin film on the electronic-paper support film according typically to vacuum deposition, sputtering, plasma chemical vapor deposition (plasma CVD), or a process using a photoresist, as in regular TFT formation.

The display layer is a layer having an image displaying function. The display layer can have any image display system, as long as having the function of image displaying by the action of electricity and/or magnetism. Exemplary image display systems usable herein include twist balls (Janus beads) display systems, electrophoretic display systems, and charged toner display systems.

The way to affix the display layer to the electronic-paper support film bearing the formed TFTs is not particularly limited, as long as capable of bringing the display layer and the electronic-paper support film bearing the formed TFTs into intimate contact with each other. These components can be affixed with each other, for example, using a roller, a lancet, or a pressing machine. When the display layer does not have a pressure-sensitive adhesive layer on its backside, the display layer can be bonded to the electronic-paper support film bearing the formed TFTs using a regular adhesive. The use of the adhesive, however, is not necessary when the display layer has a pressure-sensitive adhesive layer on its backside, so as to be bonded to the electronic-paper support film bearing the formed TFTs.

[Electronic Paper Peeling Step]

The electronic paper manufacturing method according to the present invention preferably further includes the step of peeling off (removing) the electronic paper from the support plate, after the electronic paper formation step. The removed electronic paper is recovered according to known or customary processes.

In the electronic paper peeling step, the electronic paper, which has been formed through the electronic paper formation step, is preferably peeled from the support plate by lowering the adhesive strengths of the pressure-sensitive adhesive layers in the double-sided pressure-sensitive adhesive tape.

When a double-sided pressure-sensitive adhesive tape having active-energy-ray-curable pressure-sensitive adhesive layers as the pressure-sensitive adhesive layers is used for the temporary fixing, the pressure-sensitive adhesive layers can have lowered adhesive strengths by the irradiation with an active energy ray (for example, an ultraviolet ray). Irradiation conditions such as irradiation intensity and irradiation time in the irradiation with the active energy ray are not especialy limited and can be determined as appropriate according to necessity.

When a double-sided pressure-sensitive adhesive tape having heat-peelable pressure-sensitive adhesive layers as the pressure-sensitive adhesive layers is used for the temporary fixing, the pressure-sensitive adhesive layers can have lowered adhesive strengths by heating. A heating process or device for use herein is not limited, as long as capable of heating the double-sided pressure-sensitive adhesive tape to allow the heat-expandable microspheres therein to expand and/or blister rapidly. Exemplary heating processes or devices usable herein include, but are not limited to, electric heaters; dielectric heating; magnetic heating; heating with electromagnetic waves such as near-infrared rays, mid-infrared rays, and far-infrared rays; and ovens and hot plates. The heating temperature can be any temperature at which the heat-expandable microspheres in-the double-sided pressure-sensitive adhesive tape expand and/or blister and is typically about 70° C. to 200° C. and preferably about 100° C. to 160° C.

### EXAMPLES

The present invention will be illustrated in further -detail with reference to several working examples below. It should be noted, however, that these examples are never construed to limit the scope of the present invention.

### Example 1

A toluene solution containing 100 parts by weight of a pressure-sensitive adhesive was applied to both sides of a substrate polyester film (thickness: 100 μm) and dried to form rubber-like organic elastic layers A and B thereon each having a dry thickness of 20 μm. The pressure-sensitive adhesive was composed of a copolymer derived from 30 parts by weight of 2-ethylhexyl acrylate, 70 parts by weight of ethyl acrylate, and 5 parts by weight of methyl methacrylate, and further composed of 1 part by weight of an isocyanate crosslinking agent.

Next, a toluene solution containing 100 parts by weight of a pressure-sensitive adhesive and 30 parts by weights of heat-expandable microspheres (supplied by Matsumoto Yushi-Seiyaku Co., Ltd. under the trade name of “Matsumoto Microsphere F30D”, expansion initiating temperature: about 80° C.) was applied to two plies of separators and dried to form pressure-sensitive adhesive layers A and B each having a dry thickness of 30 μm on the separators, respectively. The pressure-sensitive adhesive was a copolymer derived from 30 parts by weight of 2-ethylhexyl acrylate, 70 parts by weight of ethyl acrylate, 5 parts by weight of methyl methacrylate, and 2 parts by weight of an isocyanate crosslinking agent. The resulting pressure-sensitive adhesive layers A and B were respectively affixed onto the rubber-like organic elastic layers A and B and thereby yielded a double-sided pressure-sensitive adhesive tape 1.

A glass plate (thickness: 2.0 mm, size: 10 cm×10 cm) and a PEN film (thickness: 50 μm) were affixed with each other through the above-prepared double-sided pressure-sensitive adhesive tape 1 without causing bubbles or blowholes.

Next, TFTs were formed on the PEN film according to the following procedure:

1. a series of gate electrodes (nitrogen (N) and silicon (Si), 20 μm, 1 mm pitch) was formed on the PEN film through photolithography;

2. a nitride film (thickness: 5 μm) was formed on the gate electrodes;

3. a channel layer (hydrogenated amorphous silicon, thickness: 20 μm) was formed on the nitride film; and

4. aluminum electrodes were formed through vapor deposition, and between the electrodes, a pattern of an organic conductive material (a pentacene polymer material, a five-membered hydrocarbon) was formed through printing.

Next, a PET film (thickness: 250 μm) as a substitute for a display layer was affixed to the PEN film bearing the formed TFTs through a double-sided pressure-sensitive adhesive tape (supplied by Nitto Denko Corporation under the trade name of “No. 5000N”) and thereby yielded Sample 1.

### Example 2

Sample 2 was prepared by the procedure of Example 1, except for using, instead of the double-sided pressure-sensitive adhesive tape 1, a double-sided pressure-sensitive adhesive tape (Nitto Denko Corporation under the trade name of “No. 5000N”) for the affixation of the glass plate (thickness: 2.0 mm, size: 10 cm×10 cm) to the PEN film (thickness: 50 μm).

### Example 3

A rubber-like organic elastic layer was provided on one side of a polyester film 100 μm thick, and this was affixed to a pressure-sensitive adhesive layer being arranged on a separator and containing heat-expandable microspheres, by the procedure of Example 1. Next, a toluene solution of a pressure-sensitive adhesive was applied to the other side of the polyester film so as to have a dry thickness of 10 μm. The pressure-sensitive adhesive was composed of a copolymer derived from 30 parts by weight of 2-ethylhexyl acrylate, 70 parts by weight of ethyl acrylate, and 5 parts by weight of methyl methacrylate, and further composed of 3 parts by weight of an isocyanate crosslinking agent. Thus, a double-sided pressure-sensitive adhesive tape 3 having a heat-peelable pressure-sensitive adhesive layer provided on one side thereof was obtained. Next, Sample 3 was prepared by the procedure of Example 1, except for using the double-sided pressure-sensitive adhesive tape 3 as the double-sided pressure-sensitive adhesive tape for affixing the glass plate and the PEN film to each other. In this process, the glass plate was affixed to the (regular) pressure-sensitive adhesive layer, and the PEN film was affixed to the heat-peelable pressure-sensitive adhesive layer.

### Comparative Example 1

Sample 4 was prepared by the procedure of Example 1, except for using, instead of the double-sided pressure-sensitive adhesive tape 1, a wax (supplied by Kokonoe Electric Co., Ltd. under the trade name of “SLOT WAX”) for affixing the glass plate (thickness: 2.0 mm, size: 10 cm×10 cm) and the PEN film (thickness: 50 μm) to each other.

Evaluation Tests (Peel Time, Cleaning Time, and Amount of Solvent Used in Cleaning)

Samples 1 to 4 being obtained in the examples and comparative example and including the simulated electronic paper affixed onto the glass plate were subjected to measurements of the time (second) necessary for peeling the simulated electronic paper from glass plate, and, if the backside of the simulated electronic paper after the peeling needed cleaning, the time (second) and the amount (gram) of a solvent necessary for the cleaning. The peeling was performed by a heating treatment using a hot plate set to 100° C.

Measurement of Adhesive Strength

Samples for the measurement of adhesive strength, of a size of 130 mm (in a longitudinal direction) and 20 mm (in a cross direction), were prepared from the pressure-sensitive adhesive tape obtained in Example 1, the double-sided pressure-sensitive adhesive tape (Nitto Denko Corporation under the trade name of “No. 5000N”) used in Example 2, and the pressure-sensitive adhesive tape obtained in Example 3, respectively. Next, the adhesive strengths of the samples were measured by affixing an adhesive face of each sample to a test plate through one reciprocating movement of a 2-kg rubber roller (width: about 40 mm) thereon, leaving in an atmosphere of a temperature of 23° C. and relative humidity of 50% for 30 minutes, and performing a 180-degree peel test in accordance with JIS Z 0237. The measurement of adhesive strength was performed under the following conditions.
Apparatus: supplied by SHIMAZU Corporation under the trade name “Autograph”
Sample width: 20 mm
Tensile speed: 300 mm/minute
Peel angle: 180 degrees
Environmental temperature and humidity: 23° C., relative humidity of 50%
Number of tests as repeated: n=3

The test plate used herein was a stainless steel plate (SUS304).

The adhesive strength of the sample according to the comparative example was immeasurable.

Measurement of Gel Fraction

The toluene solution being prepared in Example 1 and containing the pressure-sensitive adhesive was applied to a silicone-treated surface of a PET separator (thickness: 38 μm) and dried to thereby form a pressure-sensitive adhesive layer having a dry thickness of 30 μm.

Next, the toluene solution being prepared in Example 1 and containing the pressure-sensitive adhesive and the heat-expandable microspheres was applied to a silicone-treated surface of a PET separator (thickness: 38 μm) and dried to thereby form a rubber-like organic elastic layer having a dry thickness of 20 μm.

The pressure-sensitive adhesive layer and the rubber-like organic elastic layer were affixed to each other, and the resulting laminate was cut to a size of 130 mm (in a longitudinal direction) and 20 mm (in a cross direction) and thereby yielded a sample for the measurement of gel fraction.

The PET separator adjacent to the pressure-sensitive adhesive layer was removed from the sample, and 5 g of the pressure-sensitive adhesive was sampled from the exposed pressure-sensitive adhesive layer, covered by a Teflon (registered trademark) sheet (supplied by Nitto Denko Corporation under the trade name of “NITOFLON”), tied with a kite string, the weight of the resulting article was measured, and this weight was defined as a weight before immersion. The weight before immersion was a total weight of the pressure-sensitive adhesive (the sampled pressure-sensitive adhesive), the Teflon (registered trademark) sheet, and the kite string. Independently, the total weight of the Teflon (registered trademark) sheet and the kite string was measured, and this weight was defined as a tare weight.

Next, the sampled pressure-sensitive adhesive covered by the Teflon (registered trademark) sheet and tied with the kite string (this article is hereinafter referred to as “specimen”) was placed in a 50-ml vessel filled with toluene and left stand at 25° C. for 7 days. The specimen after immersion in toluene was recovered from the vessel, transferred to an aluminum cup, dried in a dryer at 130° C. for 2 hours to remove toluene, and the weight of the resulting specimen was measured, and this weight was defined as a weight after immersion.

The gel fraction was then determined according to the following equation:

Gel Fraction (percent by weight)=(a−b)/(c−b)×100 (1)

wherein “a” is the weight after immersion; “b” is the tare weight; and “c” is the weight before immersion.

The gel fraction was not measured on Example 2. On Example 3, the gel fractions of both the heat-peelable pressure-sensitive adhesive layer and the (regular) pressure-sensitive adhesive layer were measured by the procedure, of Example 1.

On Comparative Example 1, the gel fraction was measured by the procedure of Example 1, except for using 5 g of the wax instead of the pressure-sensitive adhesive.

The results of evaluations (peel time, cleaning time, and amount of solvent used in cleaning) are all shown in following Table 1.

TABLE 1

| | | | Amount of solvent |
|---|---|---|---|
| | Peel time | Cleaning time | used in cleaning |
| | (second) | (second) | (g) |
| Example 1 | 5 | 0 | 0 |
| Example 2 | 40 | 0 | 0 |
| Example 3 | 15 | 0 | 0 |
| Comparative | 30 | 120 | 50 |
| Example 1 | | | |

The results of measurements (measurement of adhesive strength and measurement of gel fraction) are shown in following Table 2.

TABLE 2

| | | Adhesive strength | Gel fraction |
|---|---|---|---|
| | | (N/20 mm) | (%) |
| Example 1 | | 2.5 | 95 |
| Example 2 | | 15.0 | not measured |
| Example 3 | Heat-peelable pressure- | 2.5 | 95 |
| | sensitive adhesive layer | | |
| | Pressure-sensitive | 0.8 | 97 |
| | adhesive layer | | |

| | | |
|---|---|---|
| Comparative Example 1 | immeasurable | 10 |

As is demonstrated by Table 1, each of the double-sided pressure-sensitive adhesive tapes, when used for temporary fixing, can firmly hold-the electronic-paper support film during the electronic paper formation step and can be easily peeled off without adhesive deposit after the electronic paper formation step. Additionally, the use of the double-sided pressure-sensitive adhesive tapes eliminates the need for cleaning the backside of the electronic paper, thereby saves the time necessary for cleaning, and allows efficient production of the electronic paper. This technique allows a higher workability and is environmentally friendly, because the technique does not need the use of a solvent for cleaning.

In contrast, the use of the wax for the temporary fixing (Comparative Example 1) requires cleaning of the wax attached to the backside of the electronic paper after peeling. This cleaning process takes a long time and requires the use of a large amount of a cleaning solvent.

### INDUSTRIAL APPLICABILITY

The present invention allows easy formation of TFTs (thin film transistors) even on a thin electronic-paper support film without causing wrinkling of the electronic-paper support film.

### REFERENCE SIGNS LIST

1 substrate layer

2A, 2B rubber-like organic elastic layer

3A, 3B pressure-sensitive adhesive layer

4 separator

5 double-sided pressure-sensitive adhesive tape

6 support plate

7 electronic-paper support film

8 thin film transistor (TFT)

9 display layer (front panel)

10 electronic paper

1. A method for manufacturing an electronic paper, the method comprising an electronic paper formation step, the step including substeps of forming one or more thin film transistors on or above an electronic-paper support film to give a driver layer; and affixing a display layer having an image displaying function onto the driver layer, wherein the electronic paper formation step is performed while temporarily fixing the electronic-paper support film to a support plate through a double-sided pressure-sensitive adhesive tape.

2. The method for manufacturing an electronic paper, according to claim 1, further comprising the step of peeling off the electronic paper from the support plate after the electronic paper formation step.

3. The method for manufacturing an electronic paper, according to claim 1, wherein the double-sided pressure-sensitive adhesive tape comprises a heat-peelable pressure-sensitive adhesive layer as at least one side thereof.

4. The method for manufacturing an electronic paper, according to claim 1, wherein the double-sided pressure-sensitive adhesive tape is a heat-peelable double-sided pressure-sensitive adhesive tape comprising a substrate layer and two heat-peelable pressure-sensitive adhesive layers each containing heat-expandable microspheres, one of the adhesive layers being present on one side of the substrate layer, and the other of the adhesive layers being present on the other side of the substrate layer.

5. A double-sided pressure-sensitive adhesive tape for electronic paper formation step, adopted to the method for manufacturing an electronic paper as claimed in claim 1.

6. The method for manufacturing an electronic paper, according to claim 2, wherein the double-sided pressure-sensitive adhesive tape comprises a heat-peelable pressure-sensitive adhesive layer as at least one side thereof.

7. The method for manufacturing an electronic paper, according to claim 2, wherein the double-sided pressure-sensitive adhesive tape is a heat-peelable double-sided pressure-sensitive adhesive tape comprising a substrate layer and two heat-peelable pressure-sensitive adhesive layers each containing heat-expandable microspheres, one of the adhesive layers being present on one side of the substrate layer, and the other of the adhesive layers being present on the other side of the substrate layer.

8. The method for manufacturing an electronic paper, according to claim 3, wherein the double-sided pressure-sensitive adhesive tape is a heat-peelable double-sided pressure-sensitive adhesive tape comprising a substrate layer and two heat-peelable pressure-sensitive adhesive layers each containing heat-expandable microspheres, one of the adhesive layers being present on one side of the substrate layer, and the other of the adhesive layers being present on the other side of the substrate layer.

9. The method for manufacturing an electronic paper, according to claim 6, wherein the double-sided pressure-sensitive adhesive tape is a heat-peelable double-sided pressure-sensitive adhesive tape comprising a substrate layer and two heat-peelable pressure-sensitive adhesive layers each containing heat-expandable microspheres, one of the adhesive layers being present on one side of the substrate layer, and the other of the adhesive layers being present on the other side of the substrate layer.

10. A double-sided pressure-sensitive adhesive tape for electronic paper formation step, adopted to the method for manufacturing an electronic paper as claimed in claim 2.

11. A double-sided pressure-sensitive adhesive tape for electronic paper formation step, adopted to the method for manufacturing an electronic paper as claimed in claim 3.

12. A double-sided pressure-sensitive adhesive tape for electronic paper formation step, adopted to the method for manufacturing an electronic paper as claimed in claim 4.

13. A double-sided pressure-sensitive adhesive tape for electronic paper formation step, adopted to the method for manufacturing an electronic paper as claimed in claim 6.

14. A double-sided pressure-sensitive adhesive tape for electronic paper formation step, adopted to the method for manufacturing an electronic paper as claimed in claim 7.

15. A double-sided pressure-sensitive adhesive tape for electronic paper formation step, adopted to the method for manufacturing an electronic paper as claimed in claim 8.

16. A double-sided pressure-sensitive adhesive tape for electronic paper formation step, adopted to the method for manufacturing an electronic paper as claimed in claim 9.
